(19) United States
(12) Patent Application Publication
(10) Pub. No.: US 2006/0120850 A1
(43) Pub. Date: Jun. 8, 2006

(54) WORKPIECE HANDLING SYSTEM WITH GEOSTATIONARY EJECTION FUNCTION

(75) Inventors: JEFFREY A CLARK, ADRIAN, MI (US); WILLIAM A FRANK, ONSTED, MI (US); PHILLIP K ICKES, CLINTON, MI (US)

Correspondence Address: DYKEMA GOSSETT PLLC, 2723 SOUTH STATE STREET, SUITE 400, ANN ARBOR, MI, 48104, US

(73) Assignee: AIDCO INTERNATIONAL, INC., ADRIAN, MI (US)

(21) Appl. No.: 10/904,687

(22) Filed: Nov. 23, 2004

(51) Int. Cl. B65G 57/00

(52) U.S. Cl. 414/789.5

(57) ABSTRACT

A workpiece handling system has a geostationary ejection function in which a carrier slidingly engages and lifts workpieces. The carrier is equipped with an ejector which is moved at a velocity opposite to movement of the carrier when the carrier is being unloaded, such that workpieces being unloaded from the carrier are maintained in a geostationary position during unloading or disengagement of the workpieces from the carrier.

### FIELD OF THE INVENTION

The present invention relates to a workpiece carrier having a built-in ejection device and positioning system.

### BACKGROUND OF THE INVENTION

Workpiece carriers for material handling systems typically employ grippers or other devices for picking up and moving workpieces from an unloading station to a loading station. Bagged materials, such as shingles, present a special challenge because of the added difficulty attendant the loading and unloading such workpieces without damage to either the packaging or the enclosed goods. Moreover, when moving or transporting workpieces such as pre-packaged bags or bundles of materials, it is highly desirable to produce palletized loads having precisely stacked workpieces, so as to prevent spoilage due to disassembly or mispositioning of the stacked materials during storage and transit.

A system according to present invention provides precise and “soft” handling, location, and placement of workpieces, particularly bagged or wrapped bundles of materials, while saving labor costs due to the use of a robotically positioned carrier.

### SUMMARY OF THE INVENTION

A handling system includes a carrier for slidingly engaging and lifting workpieces. An ejector mounted to the carrier slidingly disengages workpieces from the carrier. The present workpiece handling system also includes a prime mover, such as a material handling robot, for positioning the carrier during disengagement of a workpiece such that the carrier and the ejector are moved in opposite directions, but at substantially the same velocity, so as to maintain the workpiece in a generally invariant or geostationary position during disengagement of the workpiece from the carrier.

According to another aspect of the present invention, a workpiece carrier may comprise a plurality of lifting forks arranged in a generally planar configuration, or another type of generally planar platform upon which a workpiece may be placed for repositioning.

According to another aspect of the present invention, the ejector mounted upon the carrier may be powered either by a fluid power cylinder such as a hydraulic or pneumatic cylinder or by a motor-driven actuator, or by other types of actuators known to those skilled in the art and suggested by this disclosure.

According to another aspect of the present invention, the present carrier may include at least one clamping device for maintaining a workpiece in contact with the carrier during transportation of the workpiece.

In order to permit versatility of the present workpiece handling system, the carrier may be mounted upon a robotic arm portion of a robot having, for example, multiple axes of rotation such as is commonly found with industrial robots.

According to another aspect of the present invention, a method for robotically handling a workpiece includes the steps of slidingly engaging the workpiece with a carrier mounted upon a robotic arm, and moving the carrier with the engaged workpiece from a first location to a second location. Then, the carrier is moved away from the second location, while simultaneously disengaging the workpiece from the carrier by means of an ejector, such that the workpiece is maintained in a generally invariant position during the disengagement. This characteristic of maintaining a generally invariant position during disengagement of the workpiece from the carrier is termed a geostationary ejection function; this characteristic promotes the capability to stack workpieces in an orderly fashion upon a pallet or other means of carrying such stacked workpieces. This precise positioning capability is also enhanced by clamping the workpiece to the carrier after the carrier has slidingly engaged the workpiece.

It is an advantage of the present invention that a workpiece handling system according to this invention will handle relatively sensitive material, such as bagged materials, without harming either the goods or the packaging thereof.

It is another advantage of the present invention that the geostationary ejection function may be employed to precisely stack materials on a conveyor, a pallet or other device for further moving the materials.

Other advantages, as well as objects and features of the present invention, will become apparent to the reader of this specification.

### BRIEF DESCRIPTION OF THE DRAWINGS

FIG. 1 is a perspective view of a workpiece handling system according to the present invention, shown in conjunction with a supply conveyor and a receiving station.

FIG. 2 is a perspective view of the workpiece handling system of FIG. 1.

FIG. 3 is a side elevation of a workpiece handling system according to the present invention, which is shown while in the process of engaging a workpiece comprising bagged material.

FIG. 4 is similar to FIG. 3, but illustrates the present material handling system in a carry mode.

FIG. 5 shows a carrier according to present invention as workpieces 18 are being ejected in a geostationary manner.

### DETAILED DESCRIPTION OF PREFERRED EMBODIMENTS

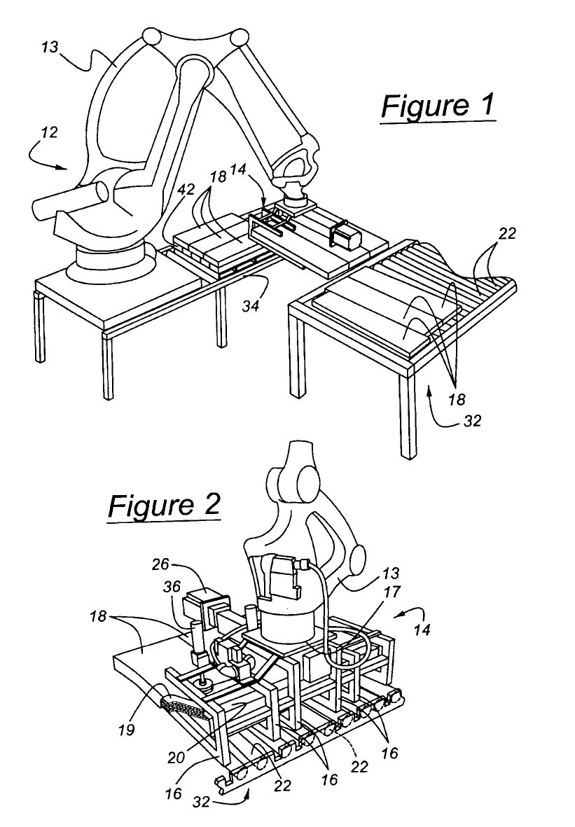

As shown in FIG. 1, robot 12, which preferably has multiple axes of rotation, has robot arm 13 mounted thereto. Carrier 14 is, in turn, mounted upon robot arm 13, and functions as an end of arm tool. In the configuration shown in FIG. 1, carrier 14 is used in connection with robot 12 to lift workpieces 18, in this case, bundles of materials or other solid or semi-solid workpieces, from supply conveyor 32 and to stack to the workpieces upon pallet 42 at pallet station 34.

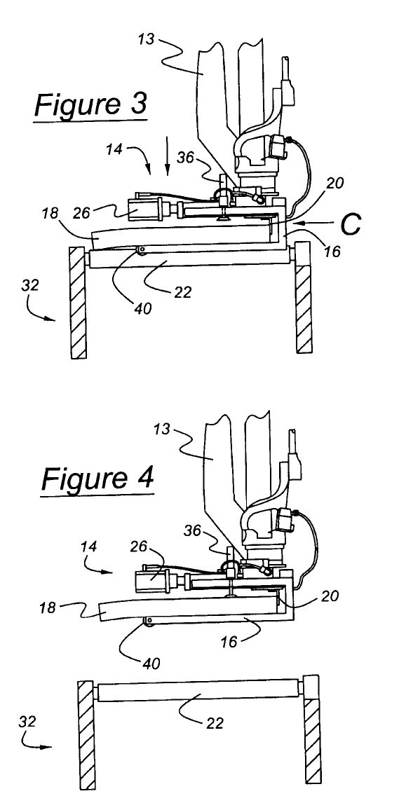

In FIG. 2, carrier 14 is shown as having a plurality of lifting forks 16 attached to base plate 17, which is in turn mounted to robot arm 13. Each of forks 16 is substantially U-shaped, and forms a portion of a generally planar configuration for supporting a number of workpieces, such as the illustrated bundles of shingles 18. Each bundle 18 contains a number of individual shingles, 19. As shown in FIGS. 1 and 3, supply conveyor 32 is equipped with a number of rollers 22, which not only permit workpieces 18 to move freely upon supply conveyor 32, but also allow passage of forks 16, so as to allow carrier 14 to approach workpieces 18 without pushing or otherwise displacing the workpieces in a lateral direction. In FIG. 3, carrier 14 has completely engaged workpiece 18, and clamp 36 has been engaged with workpiece 18.

FIG. 4 shows that workpieces 18 are substantially supported by forks 16. While being carried by forks 16 and being repositioned by robot 12, bundles 18 are held securely by clamps 36, which serve to securely maintain bundles 18 in contact with forks 16.

FIGS. 2-4 show ejector bar 20 in its parked position. Ejector bar 20 is powered by ejector cylinder 26, which may be either hydraulically or pneumatically powered, or may comprise an electrically driven lead screw, power rack, or other type of device known to those skilled in the art and suggested by this disclosure. As best seen in FIGS. 3 and 4, ejector bar 20 and ejector power cylinder 26 are intended to engage an upper corner of workpiece bundles 18, so as to physically disengage, or push, bundles 18 from carrier 14 during unloading of carrier 14. Movement of bundles 18 is aided by a plurality of rollers 40 which are mounted on the lower portion of each of forks 16.

FIGS. 3 and 4 illustrate the motions of workpieces 18 into engagement and disengagement with carrier 14. Beginning with FIG. 3, carrier 14 is shown as moving toward supply conveyor 32 in the direction “C”. As noted above, lifting forks 16 are sized to fit between adjacent rollers 22 upon supply conveyor 32. In this manner, forks 16 may be inserted under bundles 18 without injuring bundles 18 or causing them to slide. During engagement of carrier 14 with bundles 18, ejector bar 20 is maintained in its fully retracted position by power cylinder 26. FIG. 4 shows carrier 14 in its translational mode, with workpiece 18 being supported by forks 16 and retained by clamp 36.

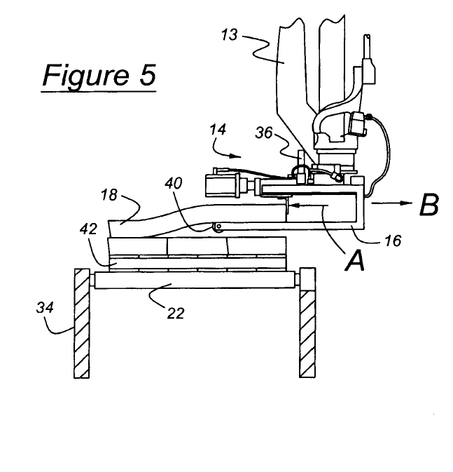

FIG. 5 shows carrier 14 during the geostationary ejection function. During disengagement of workpieces 18 from carrier 14, ejector bar 20 is moved by ejector power cylinder 26, in a direction tending to disengage workpieces 18 from carrier 14 at a predetermined velocity in a first direction, labeled as direction “A”. Simultaneously, robot 12 moves robot arm 13 and carrier 14 at the same velocity in an opposite direction, “B”. As a result, workpieces 18 are maintained in a generally invariant, or geostationary, position during the disengagement. This means that workpieces 18 may be precisely stacked upon pallet 42 at pallet station 34. As noted above, this precise stacking is aided by the use of clamps 36 (FIGS. 3-5), which prevent workpieces 18 from shifting upon forks 16 as robot 12 swings robot arm 13 through various arcs required to position the workpieces from supply conveyor 32 to pallet station 34.

Clamps 36 are released or retracted during the disengagement process. Each of forks 16 has a closed end and an open end, with the open end being equipped with a roller, 40. As shown in FIG. 5, rollers 40 allow workpieces 18 to disengage from forks 16 without tearing or other damage to the workpieces. The same is true during the engagement sequence depicted in FIG. 3, because rollers 40 permit workpieces 18 to be slidingly engaged by forks 16 without disrupting or damaging the workpieces.

Although the present invention has been described in connection with particular embodiments thereof, it is to be understood that various modifications, alterations, and adaptations may be made by those skilled in the art without departing from the spirit and scope of the invention set forth in the following claims.

What is claimed is:

1. A workpiece handling system, comprising:
a carrier for slidingly engaging and lifting a workpiece;
an ejector mounted to said carrier, for slidingly disengaging said workpiece from said carrier; and
a prime mover for positioning said carrier during disengagement of the workpiece such that said carrier and said ejector are moved in opposite directions at substantially the same velocity, so as to maintain the workpiece in a generally invariant position during disengagement of the workpiece from said carrier.

2. A workpiece handling system according to claim 1, wherein said carrier comprises a plurality of lifting forks arranged in a generally planar configuration.

3. A workpiece handling system according to claim 1, wherein said ejector is powered by a fluid power cylinder.

4. A workpiece handling system according to claim 3, wherein said ejector is powered by a hydraulic cylinder.

5. A workpiece handling system according to claim 3, wherein said ejector is powered by a pneumatic cylinder.

6. A workpiece handling system according to claim 1, wherein said ejector is powered by a motor driven actuator.

7. A workpiece handling system according to claim 1, wherein said carrier comprises a generally planar platform having a plurality of workpiece engaging rollers incorporated therein.

8. A workpiece handling system according to claim 1, wherein said prime mover comprises a robot arm.

9. A workpiece handling system according to claim 1, further comprising at least one clamping device for maintaining a workpiece in contact with said carrier.

10. A workpiece handling system according to claim 1, wherein said carrier comprises a plurality of lifting forks arranged in a generally planar configuration, with each of said forks being opposed by at least one clamping device for maintaining a workpiece in contact with said carrier.

11. A workpiece handling system according to claim 10, wherein each of said forks has a closed end and an open end, with the open end being equipped with a roller for engaging workpieces being engaged or disengaged from said carrier.

12. A robotic workpiece handling system, comprising:
a carrier for lifting a workpiece after slidingly placing the workpiece into engagement with the carrier by moving toward the workpiece in a first lateral direction;
an ejector mounted to said carrier, for slidingly disengaging said workpiece from said carrier, with said ejector moving the workpiece in said first direction relative to said carrier at a predetermined velocity when the workpiece is being disengaged; and
a robotic arm for positioning said carrier, with said robotic arm locating said carrier during disengagement of the workpiece such that said carrier and said ejector move a common distance in opposite directions during said disengagement, so as to maintain the workpiece in a generally invariant position during disengagement of the workpiece from said carrier.

13. A robotic workpiece handling system according to claim 12, wherein said robotic arm comprises a portion of a robot having at least three axes of rotation.

14. A robotic workpiece handling system according to claim 12, wherein said carrier and said ejector are adapted to handle workpieces comprising bagged materials.

15. A robotic workpiece handling system according to claim 12, wherein said carrier and said ejector are adapted to handle a plurality of workpieces comprising bundles of roofing shingles.

16. A method for robotically stacking workpieces, comprising the steps of:
slidingly engaging a workpiece with a carrier mounted upon a robotic arm;
moving the carrier and the engaged workpiece from a first location to a second stacked location; and
moving the carrier away from the stacked location while simultaneously disengaging the workpiece from said carrier by means of an ejector such that the workpiece is maintained in a generally invariant position during the disengagement.

17. The method according to claim 16, further comprising the step of clamping said workpiece to said carrier after said carrier has slidingly engaged the workpiece, but prior to beginning the step of disengaging the workpiece from the carrier.
